(19) United States
(12) Patent Application Publication
(10) Pub. No.: US 2025/0212960 A1
(43) Pub. Date: Jul. 3, 2025

(54) ELECTRONIC ATOMIZER THAT CAN AUTOMATICALLY EMIT SMOKE

(71) Applicant: Shenzhen Impetus Technology Co., Ltd., Shenzhen (CN)

(72) Inventor: Liqian Chen, Shenzhen (CN)

(21) Appl. No.: 18/420,703

(22) Filed: Jan. 23, 2024

(30) Foreign Application Priority Data
Jan. 2, 2024 (CN) 2024100030759

(51) Int. Cl. A24F 40/48; A24F 40/46; A24F 40/60; A24F 40/90; H05B 3/03

(52) U.S. Cl. CPC A24F 40/48; A24F 40/46; A24F 40/60; A24F 40/90; H05B 3/03

(57) ABSTRACT

An electronic atomizer that can automatically emit smoke comprises a base, which is provided with an assembly cavity and an assembly hole; a mounting base and an electrode, the mounting base is arranged on the assembly hole, the mounting base is provided with a first through-hole that runs through it, the electrode is arranged in the first through-hole, and the electrode is provided with a second through-hole; a ventilation part, it is provided with a first air outlet and a second air outlet that communicate with each other, the ventilation part is arranged in the assembly cavity, and the first air outlet communicates with the second through-hole; a fan, it is arranged on one side of the second air outlet and is used to supply air to the second air outlet; a mainboard, it is arranged in the assembly cavity.

### 1. TECHNICAL FIELD

The invention relates to the technical field of electronic atomizers, in particular to an electronic atomizer that can automatically emit smoke.

### 2. BACKGROUND ART

An electronic atomizer is a device that generates smoke by heating substances such as chemicals, which is then inhaled by the user. This type of electronic atomizer can be widely used in various fields, such as the medical field; patients can relieve symptoms such as coughs through atomization treatment. Additionally, electronic atomizers can also be applied in other areas. For example, they can be used to physicalize e-liquids into smoke, simulating the experience of smoking cigarettes. In other words, electronic atomizers can be applied to various fields depending on the substance being atomized.

However, current electronic atomizers require users to inhale before they can work, and they need to inhale to extract the smoke produced.

### 3. SUMMARY OF THE INVENTION

The invention provides an electronic atomizer that can automatically emit smoke to solve the technical problems mentioned in the above background art.

The technical scheme adopted by the invention is an electronic atomizer that can automatically emit smoke comprises:
A base, the base is provided with an assembly cavity and an assembly hole, and the base is also provided with an air inlet hole communicating with the assembly cavity;
A mounting base and an electrode, the mounting base is arranged on the assembly hole, the mounting base is provided with a first through-hole that runs through it, the electrode is arranged in the first through-hole, and an insulating part is arranged between the electrode and the mounting base, and the electrode is provided with a second through-hole;
A ventilation part, the ventilation part is provided with a first air outlet and a second air outlet that communicate with each other, the ventilation part is arranged in the assembly cavity, and the first air outlet communicates with the second through-hole;
A fan, the fan is arranged on one side of the second air outlet and is used to supply air to the second air outlet;
A mainboard, the mainboard is arranged in the assembly cavity, the mainboard is electrically connected to the fan, the mounting base and the electrode respectively;
An atomizer, the atomizer is connected to the mounting base, and is in contact with the electrode at the same time, the atomizer is connected to the second through-hole.

It can be seen that in this electronic atomizer described in the invention, the characteristic of the electrode needing to be in contact with the atomizer is fully utilized; the second through-hole is arranged in the electrode, allowing the second through-hole to be connected to the atomizer; in this way, the wind generated by the fan can be guided through the ventilation part to the second through-hole of the electrode, and blown towards the atomizer through the second through-hole, so that the smoke generated by the atomizer to be automatically emitted. This method makes the structure of the electronic atomizer simple and makes assembly more convenient.

As a preferred scheme of the invention, threads can be arranged on the side wall of the first through-hole, and the atomizer is threadedly connected to the mounting base.

As a preferred scheme of the invention, it can also comprise a housing, the housing can be detachably connected to the base, the housing is provided with an accommodating cavity, the accommodating cavity has an opening, the atomizer is accommodated in the accommodating cavity through the opening;

A smoke outlet can be arranged at one end of the housing away from the base, the smoke outlet is in communication with the accommodating cavity.

As a preferred scheme of the invention, an installation hole can also be arranged at one end of the base close to the housing;

A mouthpiece is arranged in the installation hole and electrically connected to the mainboard;

An air passage is arranged between the atomizer and the accommodating cavity, and the air passage is in communication with the installation hole.

As a preferred scheme of the invention, the opening of the accommodating cavity can be extended to one side to form an avoiding space, the avoiding space is connected to the air passage and the installation hole respectively.

As a preferred scheme of the invention, the housing and the base can be connected by magnetic attraction.

As a preferred scheme of the invention, a battery is arranged in the housing, a spring contact is connected to the mainboard, and the spring contact extends to one end of the base close to the housing, the spring contact is used to contact the battery.

As a preferred scheme of the invention, it can further comprise a fixed base, the fixed base is provided with an installation cavity, and the fixed base is provided with a third air outlet and a fourth air outlet that communicate with the installation cavity; the fixed base is arranged in the assembly cavity, the third air outlet is connected with the second air outlet, the fourth air outlet is connected with the assembly cavity, and the fan is arranged in the installation cavity.

As a preferred scheme of the invention, a button or a charging connector can be arranged within the air inlet hole, the button or charging connector is connected to the mainboard.

As a preferred scheme of the invention, it can also comprise a cigarette holder, the cigarette holder is arranged at one end of the housing away from the base, and is connected to the smoke outlet.

### 4. BRIEF DESCRIPTION OF ACCOMPANY DRAWINGS

In order to clarify the technical schemes of the embodiments of the invention more clearly, the accompanying drawings needed to be used in the description of the embodiments or prior art will be briefly introduced below. Obviously, the accompanying drawings in the following description are only some embodiments of the invention. For those of ordinary skill in the art, other accompanying drawings can be obtained based on these accompanying drawings without exerting any creative effort.

FIG. 1 is an exploded schematic diagram of an electronic atomizer that can automatically emit smoke provided by the invention;

FIG. 2 is a cross-sectional view of an electronic atomizer that can automatically emit smoke provided by the invention.

### ATTACHED DRAWINGS MARKS

100 base; 110 assembly cavity; 120 installation hole; 130 fixed base;
200 mounting base; 210 insulating part;
300 electrode; 310 second through-hole;
1400 ventilation part; 500 fan;
600 mainboard; 610 spring contact;
700 housing; 710 smoke outlet; 720 air passage; 730 avoiding space;
800 mouthpiece; 900 atomizer;
1000 battery; 1100 button; 1200 charging connector; 1300 cigarette holder; 1400 airflow.

### 5. SPECIFIC EMBODIMENT OF THE INVENTION

In order to make the technical problems, technical schemes and advantageous effects to be solved by the invention more clear, the invention will be further described in detail below in combination with the accompanying drawings and embodiments. It should be understood that the specific embodiments described here are only used to explain the invention and are not intended to limit the invention.

It should be noted that when an element is referred to as being “fixed to” or “arranged on” another element, it can be directly on the other element or indirectly on the other element. When an element is referred to as being “connected” to another element, it can be directly connected to the other element or indirectly connected to the other element.

It should be understood that the orientation or positional relationship indicated by the terms “length”, “width”, “upper”, “lower”, “front”, “back”, “left”, “right”, “vertical”, “horizontal”, “top”, “bottom”, “inner”, “outer” and so on are based on the orientation or positional relationship shown in the accompanying drawings, only for the convenience of describing the invention and simplifying the description, rather than indicating or implying that the indicated device or element must have a specific orientation, as well as a specific orientation structure and operation, therefore, it should not be construed as a limitation of the invention.

In addition, the terms of “first”, “second” are only used to describe the object, and should not be construed as indicating or implying relative importance or implicitly indicating the quantity of indicated technical features. Therefore, the features defined as “first”, “second” may explicitly or implicitly include one or more of these features. In the description of the invention, “a plurality of” means two or more, unless otherwise expressly and specifically limited.

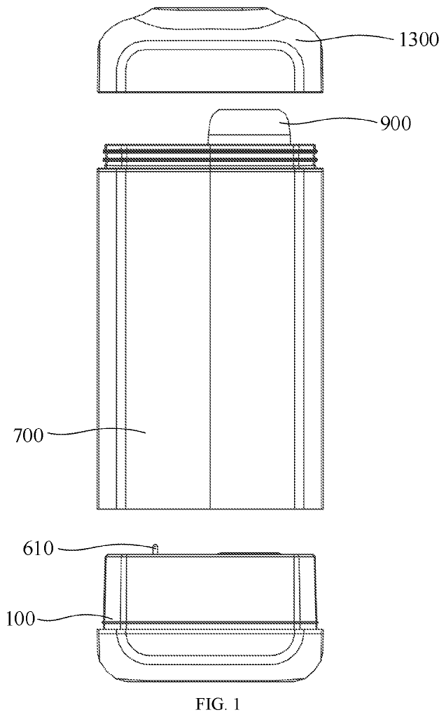

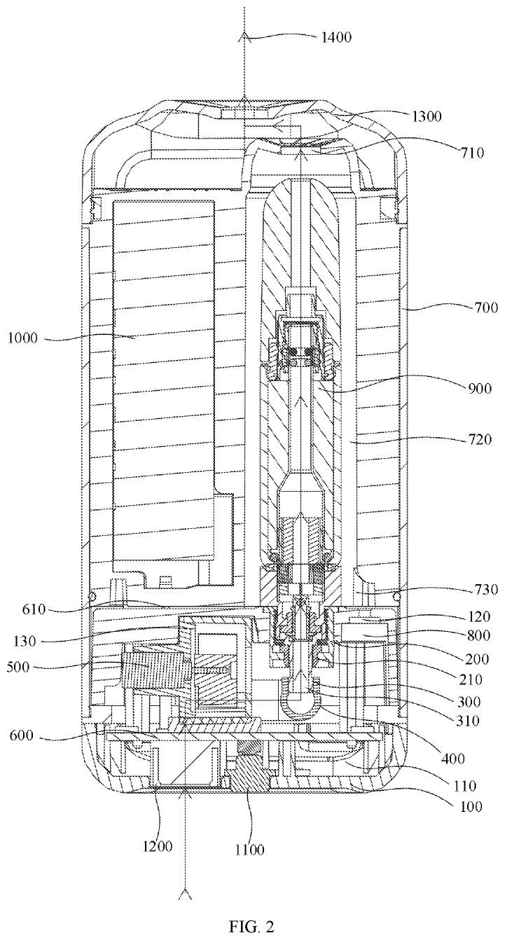

Referring to FIG. 1 and FIG. 2, the invention provides an electronic atomizer that can automatically emit smoke, comprising a base 100, a mounting base 200, an electrode 300, a ventilation part 400, a fan 500, a mainboard 600 and an atomizer 900.

Wherein, the base 100 is provided with an assembly cavity 110 and an assembly hole (not shown in the figures), and the base 100 is also provided with an air inlet hole communicating with the assembly cavity 110. In some embodiments, the assembly hole can be arranged at one end of the base 100 and the air inlet hole can be arranged at the other end of the base 100.

The mounting base 200 is arranged on the assembly hole, the mounting base 200 is provided with a first through-hole (not shown in the figures) that runs through it, the electrode 300 is arranged in the first through-hole, and an insulating part 210 is arranged between the electrode 300 and the mounting base 200, and the electrode 300 is provided with a second through-hole 310. In some embodiments, the insulating part 210 can be made of silicone, and the electrode 300 can be fixed in the first through-hole of the mounting base 200 through silicone; at this time, the mounting base 200 and the electrode 300 can serve as the positive and negative electrodes of the electronic atomizer 900.

The ventilation part 400 is provided with a first air outlet and a second air outlet that communicate with each other, the ventilation part 400 is arranged in the assembly cavity 110, and the first air outlet communicates with the second through-hole 310. In some embodiments, the first air outlet can be sleeved with the second through-hole 310 to achieve communication between the first air outlet and the second through-hole 310.

The fan 500 is arranged on one side of the second air outlet and is used to supply air to the second air outlet.

The mainboard 600 is arranged in the assembly cavity 110, the mainboard 600 is electrically connected to the fan 500, the mounting base 200 and the electrode 300 respectively.

The atomizer 900 is connected to the mounting base 200, and is in contact with the electrode 300 at the same time, the atomizer 900 is connected to the second through-hole 310. It can be understood that when the atomizer 900 is connected to the mounting base 200 and in contact with the electrode 300 at the same time, it achieves the connection between the atomizer 900 and the positive and negative electrodes.

During use, the mainboard 600 can control the operation of the fan 500 and the atomizer 900. The wind generated by the fan 500 is blown towards the atomizer 900 through the ventilation part 400, allowing the generated smoke from the atomizer 900 to be blown out, making it convenient for users to directly inhale.

It should be noted that the atomizer 900 in existing technology generally has a smoke passage, which is the structure of the smoke generated. Therefore, when the atomizer 900 is installed on the mounting seat 200 and in contact with electrode 300, the smoke passage of the atomizer 900 can be connected to the second through-hole 310 of the electrode 300.

It can be seen that in this electronic atomizer 900 described in the invention, the characteristic of the electrode 300 needing to be in contact with the atomizer 900 is fully utilized; the second through-hole 310 is arranged in the electrode 300, allowing the second through-hole 310 to be connected to the atomizer 900; in this way, the wind generated by the fan 500 can be guided through the ventilation part 400 to the second through-hole 310 of the electrode 300, and blown towards the atomizer 900 through the second through-hole 310, so that the smoke generated by the atomizer 900 to be automatically emitted. This method makes the structure of the electronic atomizer 900 simple and makes assembly more convenient.

Further, in order to facilitate the connection between the atomizer 900 and the mounting base 200 and to facilitate the replacement of the atomizer 900, threads can be arranged on the side wall of the first through-hole, and the atomizer 900 is threadedly connected to the mounting base 200.

Referring to FIG. 2, the electronic atomizer 900 can also comprise a housing 700, the housing 700 can be detachably connected to the base 100. For example, the housing 700 and the base 100 can be connected by magnetic attraction. The housing 700 is provided with an accommodating cavity (not indicated in the figures), the accommodating cavity has an opening. When the housing 700 is connected to the base 100, the atomizer 900 is accommodated in the accommodating cavity through the opening. It can be understood that the atomizer 900 is accommodated in the accommodating cavity of the housing 700, which serves to protect the atomizer 900.

Furthermore, a smoke outlet 710 can be arranged at one end of the housing 700 away from the base 100, the smoke outlet 710 is in communication with the accommodating cavity; in this way, the smoke generated by the atomizer 900 can flow out through the smoke outlet 710 and be inhaled by the user.

Referring to FIG. 2, an installation hole 120 can also be arranged at one end of the base 100 close to the housing 700, a mouthpiece 800 is arranged in the installation hole 120 and electrically connected to the mainboard 600, an air passage 720 is arranged between the atomizer 900 and the accommodating cavity, such as the the side wall of the accommodating cavity, and the air passage 720 is in communication with the installation hole 120.

When the user does not want the electronic vaporizer 900 to automatically emit smoke, and when the user inhales, under the effect of the air passage 720, the external airflow 1400 flows sequentially through the air inlet hole and assembly hole to the installation hole 120, allowing the mouthpiece 800 to sense the airflow 1400, thereby enabling the mainboard 600 to control the operation of the atomizer 900, achieving the normal operation of the electronic atomizer 900, that is, the user can extract the smoke generated by the atomizer 900 by inhaling.

Furthermore, when the user inhales, in order to facilitate the airflow 1400 at the installation hole 120 to flow into the air passage 720, the opening of the accommodating cavity can be extended to one side to form an avoiding space 730, the avoiding space 730 is connected to the air passage 720 and the installation hole 120 respectively; in this way, when the housing 700 is installed on the base 100, the avoiding space 730 can precisely expose the installation hole 120 on the base 100, allowing the airflow 1400 to pass through the mounting hole 120 and then flow into the air passage 720.

Referring to FIG. 2, the electronic atomizer 900 can also comprise a battery 1000, the battery 1000 is arranged in the housing 700, a spring contact 610 is connected to the mainboard 600, and the spring contact 610 extends to one end of the base 100 close to the housing 700, the spring contact 610 is used to contact the battery 1000 to realize the electrical connection between the battery 1000 and the mainboard 600.

Specifically, the housing 700 can also be provided with a battery 1000 compartment, the battery 1000 can be placed in the battery 1000 compartment. On one hand, this allows for convenient installation of the battery 1000; on the other hand, it facilitates the installation of the fan 500 on the base 100.

Referring to FIG. 2, in some embodiments, the electronic atomizer 900 can further comprise a fixed base 130, the fixed base 130 is provided with an installation cavity, and the fixed base 130 is provided with a third air outlet and a fourth air outlet that communicate with the installation cavity; the fixed base 130 is arranged in the assembly cavity 110, the third air outlet is connected with the second air outlet, the fourth air outlet is connected with the assembly cavity 110, and the fan 500 is arranged in the installation cavity.

When the fan 500 is in operation, the airflow 1400 in the assembly cavity 110 flows into the installation cavity through the fourth air outlet; then, under the action of the fan 500, it flows from the third air outlet into the ventilation part 400, and finally flows from the ventilation part 400 to the second through-hole 310 and then enters the atomizer 900. This approach ensures that the airflow 1400 generated by the fan 500 can all flow through the ventilation part 400 and reach the atomizer 900; it increases the flow rate and velocity of the airflow 1400, ensuring that the smoke produced by the atomizer 900 can be blown out.

In addition, in some embodiments, the electronic atomizer 900 can also comprise a button 1100 and/or a charging connector 1200; wherein the button 1100 or the charging connector 1200 can be arranged within the air inlet hole; this approach fully utilizes the structure of the air inlet hole without affecting the airflow 1400 entering the assembly cavity 110 through the air inlet hole. It can be understood that the airflow 1400 only needs gaps to enter the circulation; therefore, when the button 1100 or the charging connector 1200 is arranged within the air inlet hole, the gaps between the button 1100 or the charging connector 1200 and the sidewall of the air inlet hole will allow the airflow 1400 to enter.

In addition, in some embodiments, the electronic atomizer 900 can also comprise a cigarette holder 1300, the cigarette holder 1300 is arranged at one end of the housing 700 away from the base 100, and is connected to the smoke outlet 710. The smoke generated by the atomizer 900 flows towards the cigarette holder 1300 through the smoke outlet 710 and is inhaled by the user.

The above are only preferred embodiments of the invention and are not intended to limit the invention. Any modifications, equivalent substitutions and improvements made within the spirit and principles of the invention should be included within the protection scope of the invention.

1. An electronic atomizer that can automatically emit smoke comprises:
A base, the base is provided with an assembly cavity and an assembly hole, and the base is also provided with an air inlet hole communicating with the assembly cavity;
A mounting base and an electrode, the mounting base is arranged on the assembly hole, the mounting base is provided with a first through-hole that runs through it, the electrode is arranged in the first through-hole, and an insulating part is arranged between the electrode and the mounting base, and the electrode is provided with a second through-hole;
A ventilation part, the ventilation part is provided with a first air outlet and a second air outlet that communicate with each other, the ventilation part is arranged in the assembly cavity, and the first air outlet communicates with the second through-hole;
A fan, the fan is arranged on one side of the second air outlet and is used to supply air to the second air outlet;
A mainboard, the mainboard is arranged in the assembly cavity, the mainboard is electrically connected to the fan, the mounting base and the electrode respectively;
An atomizer, the atomizer is connected to the mounting base, and is in contact with the electrode at the same time, the atomizer is connected to the second through-hole.

2. An electronic atomizer that can automatically emit smoke of claim 1, threads can be arranged on the side wall of the first through-hole, and the atomizer is threadedly connected to the mounting base.

3. An electronic atomizer that can automatically emit smoke of claim 1, it can also comprise a housing, the housing can be detachably connected to the base, the housing is provided with an accommodating cavity, the accommodating cavity has an opening, the atomizer is accommodated in the accommodating cavity through the opening;
A smoke outlet can be arranged at one end of the housing away from the base, the smoke outlet is in communication with the accommodating cavity.

4. An electronic atomizer that can automatically emit smoke of claim 3, an installation hole can also be arranged at one end of the base close to the housing;
A mouthpiece is arranged in the installation hole and electrically connected to the mainboard;
An air passage is arranged between the atomizer and the accommodating cavity, and the air passage is in communication with the installation hole.

5. An electronic atomizer that can automatically emit smoke of claim 4, the opening of the accommodating cavity can be extended to one side to form an avoiding space, the avoiding space is connected to the air passage and the installation hole respectively.

6. An electronic atomizer that can automatically emit smoke of claim 3, the housing and the base can be connected by magnetic attraction.

7. An electronic atomizer that can automatically emit smoke of claim 3, a battery is arranged in the housing, a spring contact is connected to the mainboard, and the spring contact extends to one end of the base close to the housing, the spring contact is used to contact the battery.

8. An electronic atomizer that can automatically emit smoke of claim 1, it can further comprise a fixed base, the fixed base is provided with an installation cavity, and the fixed base is provided with a third air outlet and a fourth air outlet that communicate with the installation cavity; the fixed base is arranged in the assembly cavity, the third air outlet is connected with the second air outlet, the fourth air outlet is connected with the assembly cavity, and the fan is arranged in the installation cavity.

9. An electronic atomizer that can automatically emit smoke of claim 1, a button or a charging connector can be arranged within the air inlet hole, the button or charging connector is connected to the mainboard.

10. An electronic atomizer that can automatically emit smoke of claim 3, it can also comprise a cigarette holder, the cigarette holder is arranged at one end of the housing away from the base, and is connected to the smoke outlet.
